(19) United States
(12) Patent Application Publication
(10) Pub. No.: US 2020/0095473 A1
(43) Pub. Date: Mar. 26, 2020

(54) PRESSURE-SENSITIVE ADHESIVE SHEET FOR ELECTRONIC DEVICES

(71) Applicant: NITTO DENKO CORPORATION, Osaka (JP)

(72) Inventors: Shigeki Watanabe, Ibaraki-shi (JP); Masahito Niwa, Ibaraki-shi (JP); Masataka Nishiwaki, Ibaraki-shi (JP); Kazuki Minoura, Ibaraki-shi (JP)

(73) Assignee: NITTO DENKO CORPORATION, Osaka (JP)

(21) Appl. No.: 16/576,948

(22) Filed: Sep. 20, 2019

(30) Foreign Application Priority Data
Sep. 25, 2018 (JP) 2018-179171

(51) Int. Cl. C09J 7/38; C09J 11/06; B32B 27/06

(52) U.S. Cl. CPC C09J 7/383; B32B 27/06; C09J 11/06

(57) ABSTRACT

Provided is a PSA sheet for use in electronic devices. The PSA sheet has a PSA layer formed from a natural rubber-based PSA. The base polymer of the PSA comprises a methyl methacrylate-modified natural rubber and at least 50% of all carbons in the PSA layer comes from biomass-derived carbons. The PSA sheet shows a displaced length of 1.0 mm/60 min or less in a heat-resistant holding power test carried out at 80° C.

### CROSS-REFERENCE

The present application claims priority to Japanese Patent Application No. 2018-filed on Sep. 25, 2018, whose entire content is incorporated herein by reference.

### BACKGROUND OF THE INVENTION

### 1. Field of the Invention

The present invention relates to a pressure-sensitive adhesive sheet for use in electronic devices.

### 2. Description of the Related Art

In general, pressure-sensitive adhesive (PSA) exists as a soft solid (a viscoelastic material) in a room temperature range and has a property to adhere easily to an adherend with some pressure applied. With such properties, PSA is widely used as a joining means having high operability and high reliability of adhesion typically in the form of a PSA sheet including a layer of the PSA in various industrial fields such as home appliances, automobiles, various types of machinery, electrical equipment, and electronic equipment. A PSA sheet is also preferably used, for example, for fixing components of electronic devices such as mobile phones, smart phones, and tablet-type personal computers. Documents disclosing this type of conventional art include Japanese Patent No. 6104500 and Japanese Patent Application Publication No. 2015-221847.

### SUMMARY OF THE INVENTION

Conventionally, as for PSA sheets for electronic device applications, acrylic PSA comprising an acrylic polymer as the base polymer has been mainly used (e.g. Japanese Patent No. 6104500). With respect to non-acrylic PSA, for instance, as in Japanese Patent Application Publication No. 2015-221847, it has been suggested to use a rubber-based PSA in which a rubber-based block copolymer such as styrene-butadiene block copolymer is used as the base polymer.

Here, both the acrylic polymer and the rubber-based block copolymer are mainly typically obtained by mainly using fossil resources such as petroleum. On the other hand, in late years, much attention has been placed on environmental problems such as global warming with expectations for reducing the usage of materials based on fossil resources such as petroleum. Under such circumstances, with respect to PSA sheets for use in electronic devices, it is also desired to reduce the usage of fossil-resource-based materials. However, it has not been easy to obtain a high-performance PSA sheet suited for electronic device applications while reducing the dependence on fossil-resource-based materials.

The present invention has been made in view of these circumstances with an objective to provide a PSA sheet with reduced dependence on materials based on fossil resources and is also suited for use in electronic devices.

The present description provides a PSA sheet for use in an electronic device, the PSA sheet having a PSA layer formed from a natural rubber-based PSA. The PSA sheet shows a displaced length of 1.0 mm/60 min or less in a heat-resistant holding power test carried out at 80° C. The PSA includes a base polymer comprising a natural rubber modified with methyl methacrylate (MMA). Of the total carbon content of the PSA layer, biomass-derived carbons account for at least 50%. In other words, the PSA layer has a biomass carbon ratio of 50% or higher. Having a PSA layer formed from a natural rubber-based PSA comprising the MMA-modified natural rubber, the PSA sheet is constituted to show high heat-resistant holding properties while achieving at least 50% biomass carbon ratio in the PSA layer. Such a PSA sheet with high heat-resistant holding properties is suited for electronic device applications (e.g. for fixing parts of electronic devices) that require high performance.

The MMA-modified natural rubber content of the base polymer is preferably 40% by weight or higher and 100% by weight or lower. The PSA having such a composition is likely to bring about a PSA sheet that shows the heat-resistant holding properties described above.

In a preferable embodiment, the PSA layer comprises a crosslinking agent. With the use of the crosslinking agent, the heat-resistant holding properties can be effectively enhanced. The crosslinking agent is preferably selected among sulfur-free crosslinking agents. A sulfur-free crosslinking agent is used as the crosslinking agent to avoid incorporation of sulfur from the crosslinking agent into the PSA layer. This can be an advantageous feature in the PSA sheet for use in electronic devices.

In a preferable embodiment, the PSA layer comprises a tackifier derived from a plant. The use of the plant-derived tackifier may improve the properties (e.g. heat-resistant holding properties and/or peel strength) of the PSA sheet. From the standpoint of obtaining greater effects of the use of tackifier, the tackifier content is usually preferably 30 parts by weight or greater to 100 parts by weight of the base polymer.

The PSA sheet according to a preferable embodiment has a peel strength to stainless steel plate of 5 N/20 mm or greater. Such a PSA sheet is suited for electronic device applications (e.g. for fixing parts of electronic devices) that require high performance.

The PSA sheet disclosed herein is preferably formed as an adhesively double-faced (double-sided) PSA sheet, that is, a double-faced PSA sheet. The double-faced PSA sheet is suited for, for instance, fixing parts.

In the PSA sheet disclosed herein, at least 50% of the total carbon content thereof is preferably attributed to biomass-derived carbons. In other words, the PSA sheet has an overall biomass carbon ratio of 50% or higher. By increasing the biomass carbon ratio of the entire PSA sheet, the usage of fossil-resource-based materials can be effectively reduced.

The PSA sheet disclosed herein has high heat-resistant holding properties; and therefore, it shows excellent holding properties with respect to parts. Accordingly, it is suited for fixing parts of electronic devices.

### BRIEF DESCRIPTION OF THE DRAWINGS

FIG. 1 shows a cross-sectional diagram schematically illustrating the constitution of the PSA sheet according to an embodiment.

FIG. 2 shows a cross-sectional diagram schematically illustrating the constitution of the PSA sheet according to another embodiment.

FIG. 3 shows a cross-sectional diagram schematically illustrating the constitution of the PSA sheet according to another embodiment.

### DETAILED DESCRIPTION OF THE INVENTION

Preferred embodiments of the present invention are described below. Matters necessary to practice this invention other than those specifically referred to in this description may be comprehended by a person of ordinary skill in the art based on the instruction regarding implementations of the invention according to this description and the common technical knowledge in the pertinent field. The present invention can be practiced based on the contents disclosed in this description and common technical knowledge in the subject field.

In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate sizes or reduction scales of the PSA sheet to be provided as an actual product by the present invention.

The PSA sheet disclosed herein includes a PSA layer. The PSA sheet may be, for instance, a substrate-free double-faced PSA sheet having a first adhesive face formed of one surface of the PSA layer and a second adhesive face formed of the other surface of the PSA layer. Alternatively, the PSA sheet disclosed herein may be a substrate-supported PSA sheet in which the PSA layer is layered on one or each face of a support substrate. Hereinafter, the support substrate may be simply referred to as a “substrate.”

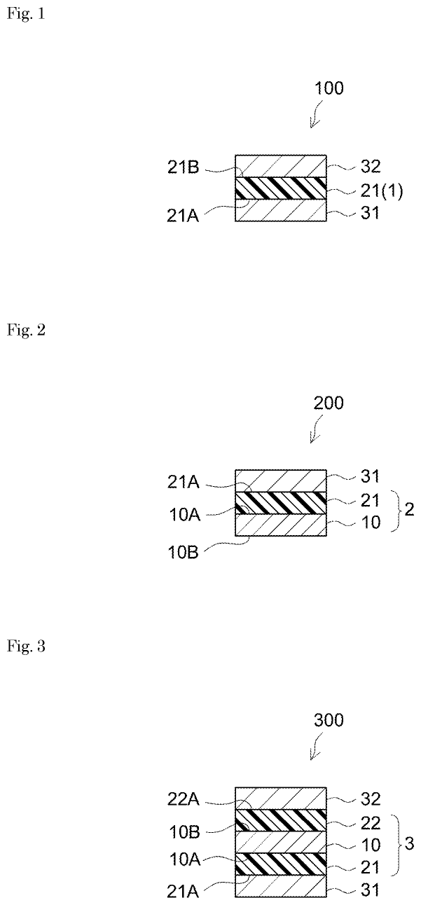

FIG. 1 schematically illustrates the structure of the PSA sheet according to an embodiment. PSA sheet 1 is configured as a substrate-free double-faced PSA sheet formed of a PSA layer 21. PSA sheet 1 is used by applying the first adhesive face 21A formed of one surface (first face) of PSA layer 21 and the second adhesive face 21B formed of the other surface (second face) of PSA layer 21 to different locations of adherend(s). The locations to which the adhesive faces 21A and 21B are applied can be the corresponding locations of different members or different locations of a single member. As shown in FIG. 1, PSA sheet 1 prior to use (i.e. before applied to an adherend) may be a constituent of a release-linered PSA sheet 100 in which the first and second adhesive faces 21A and 21B are protected by release liners 31 and 32 each having a release face at least on the side facing the PSA layer 21. The release liners 31 and 32 which may be preferably used are, for example, those respectively having a release layer provided by treatment with a release agent on one side of a sheet-shaped substrate (liner substrate) so that the side serves as a release surface. Alternatively, omitting release liner 32, a release liner 31 having release faces on both sides may be used; this and the PSA sheet 1 may be layered and wound together to form a roll of a release-linered PSA sheet in which the second adhesive face 21B is abutted and protected by the backside of release liner 31.

FIG. 2 schematically illustrates the structure of a PSA sheet according to an embodiment. The PSA sheet 2 is configured as a single-faced PSA sheet with a substrate, including a support substrate sheet (such as a resin film) 10 having a first surface 10A and a second surface 10B, and a PSA layer 21 provided on the side of the first surface 10A. The PSA layer 21 is provided securely on the side of the first surface 10A of the support substrate 10, namely provided without intending to separate the PSA layer 21 from the support substrate 10. As shown in FIG. 2, PSA sheet 2 prior to use may be a constituent of a release-linered PSA sheet 200 in which the surface (adhesive face) 21A of the PSA layer 21 is protected by release liner 31 having a release surface at least on the side facing the PSA layer 21. Alternatively, omitting release liner 31, a support substrate 10 having a second surface 10B that serves as a release surface may be used and PSA sheet 2 may be wound to form a roll in which the adhesive face 21A is abutted and protected by the second face (backside) 10B of support substrate 10.

FIG. 3 schematically illustrates the structure of the PSA sheet according to yet another embodiment. PSA sheet 3 is configured as a substrate-supported double-faced PSA sheet comprising a support substrate sheet (e.g. resin film) 10 having first and second faces 10A and 10B, a first PSA layer 21 fixed to the first face 10A side and a second PSA layer 22 fixed to the second face 10B side. As shown in FIG. 3, PSA sheet 3 prior to use may be a constituent of a release-linered PSA sheet 300 in which the surfaces (first and second adhesive faces) 21A and 22A of PSA layer 21 are protected by release liners 31 and 32. Alternatively, omitting release liner 32, a release liner 31 having release faces on both sides may be used; this and the PSA sheet 3 may be layered and wound together to form a roll of a release-linered PSA sheet in which the second adhesive face 22A is abutted and protected by the backside of release liner 31.

As the release liner, it is possible to use a release liner having a release layer on the surface of a liner substrate such as resin film and paper or a release liner formed from a low-adhesive material such as a polyolefinic resin (e.g. polyethylene, polypropylene) and a fluororesin. The release layer can be formed by subjecting the liner substrate to surface treatment with a release agent such as a silicone-based, long-chain alkyl-based, fluorine-based agent, and molybdenum sulfide. For use in electronic devices, from the standpoint of avoiding the occurrence of paper dust, a release liner having a release layer on the surface of resin film or a release liner formed from a low-adhesive material is preferable.

The concept of PSA sheet herein encompasses so-called PSA tape, PSA film, PSA labels and the like. The PSA sheet disclosed herein may be in a roll form or in a flat sheet form. The PSA sheet may be further processed into various shapes.

### <PSA Layer>

### (Biomass Carbon Ratio)

The PSA sheet disclosed herein is characterized by the PSA layer having a biomass carbon ratio (or biobased content) of 50% or higher. A high biomass carbon ratio of the PSA layer means low usage of fossil-resource-based materials typified by petroleum and the like. From such a standpoint, it can be said that the higher the biomass carbon ratio of the PSA layer is, the more preferable it is. For instance, the biomass carbon ratio of the PSA layer can be 60% or higher, 70% or higher, 75% or higher, or even 80% or higher. The maximum biomass carbon ratio is 100% by definition; however, in the PSA layer disclosed herein, because the base polymer of the PSA includes a repeat unit derived from MMA, the biomass carbon ratio is typically below 100%. From the standpoint of facilitating to bring about (e.g. heat-resistant holding properties) suited for use in electronic devices, in some embodiments, the biomass carbon ratio of the PSA layer can be, for instance, 95% or lower. When adhesive properties are of greater importance, it can be 90% or lower, or even 85% or lower. It is noted that the biobased content of general acrylic PSA is about zero to 30%; or at most, it is less than 40%.

As used herein, the biomass-derived carbon refers to carbon (renewable carbon) derived from a biomass material, that is, a material derived from a renewable organic resource. The biomass material refers to a material derived from a bioresource (typically a photosynthetic plant) that is continuously renewable typically in the sole presence of sun light, water and carbon dioxide. Accordingly, the concept of biomass material excludes materials based on fossil resources (fossil-resource-based materials) that are exhausted by using after mining. The PSA layer's biomass carbon ratio (i.e. the ratio of biomass-derived carbons to the total carbon content of the PSA layer) can be estimated from the carbon-14 isotope content determined based on ASTM D6866.

### (Base Polymer)

The PSA sheet disclosed herein has a PSA layer formed from a natural rubber-based PSA. The natural rubber-based PSA refers to a PSA whose base polymer include more than 50% natural-rubber-based polymer(s) which can be one, two or more species of polymers selected among natural rubbers and modified natural rubbers. Herein, the concept of natural-rubber-based polymer encompasses both natural rubbers and modified natural rubbers. The base polymer of the PSA refers to a rubbery polymer in the PSA. The rubbery polymer refers to a polymer that shows rubber elasticity in a temperature range around room temperature. In addition to the natural-rubber-based polymer(s), the base polymer of the PSA may include a non-natural-rubber-based polymer as a secondary component. Examples of the non-natural-rubber-based polymer include acrylic polymers, synthetic rubber-based polymers, polyester-based polymers, urethane-based polymers, polyether-based polymers, silicone-based polymers, polyamide-based polymers and fluoropolymers known in the field of PSA.

In the art disclosed herein, the base polymer of the PSA comprises a natural rubber modified with methyl methacrylate (MMA). With the MMA-modified natural rubber content, the cohesive strength of the natural rubber-based PSA can be increased with enhanced heat-resistant holding properties. This can bring about, for instance, a PSA sheet suited for fixing parts of electronic devices without requiring the use of a vulcanizer or sulfur-containing vulcanization accelerator.

The MMA-modified natural rubber used in the PSA sheet disclosed herein is typically a natural rubber grafted with methyl methacrylate. Of the weight of the MMA-modified natural rubber, the ratio of the weight of the MMA-derived repeat unit (or the MMA modification rate) should be in the range above 0% by weight and below 100% by weight; and it is not particularly limited. From the standpoint of enhancing the effect to increase the heat-resistant holding properties, the MMA modification rate is usually suitably 1% by weight or higher, possibly 5% by weight or higher, 10% by weight or higher, or even 15% by weight or higher. From the standpoint of facilitating to obtain greater heat-resistant holding properties (a smaller displaced length), in some embodiments, the MMA modification rate can be, for instance, above 20% by weight, 24% by weight or higher, 28% by weight or higher, 33% by weight or higher, 35% by weight or higher, 38% by weight or higher, or even 40% by weight or higher. From the standpoint of increasing the biomass carbon ratio, the MMA modification rate is usually suitably below 80% by weight, preferably below 70% by weight, possibly below 60% by weight, below 55% by weight, below 50% by weight, or even below 45% by weight.

The MMA-modified natural rubber can be produced by a known method or a commercially-available product can be used. Examples include a method where addition polymerization is carried out upon addition of MMA to the natural rubber, a method where a pre-formed oligomer of MMA is mixed with and added onto the natural rubber, and an intermediate method between these. The ratio between the natural rubber and the MMA as well as other production conditions can be suitably selected so as to obtain an MMA-modified natural rubber having a desired MMA modification rate. The natural rubber used in production of the MMA-modified natural rubber is not particularly limited. For instance, a suitable species can be selected among various natural rubbers that are generally available, such as a ribbed smoked sheet (RSS), pale crepe, standard Malaysian rubber (SMR) and standard Vietnamese rubber (SVR). When a natural rubber is used in combination with the MMA-modified natural rubber, the natural rubber can also be selected among the same various natural rubbers. The natural rubber is typically used upon mastication by a usual method.

The Mooney viscosity of the natural rubber used in producing the MMA-modified natural rubber is not particularly limited. For instance, it is possible to use a natural rubber having a Mooney viscosity MS₁₊₄(100° C.) (i.e. a Mooney viscosity determined at MS (1+4) 100° C.) in a range of about 10 or greater and 120 or less. The natural rubber's Mooney viscosity MS₁₊₄(100° C.) can be, for instance, 100 or less, 80 or less, 70 or less, or even 60 or less. With decreasing Mooney viscosity MS₁₊₄(100° C.), it tends to readily show initial tack. This is advantageous in increasing the efficiency of application to adherend. From such a standpoint, in some embodiments, the Mooney viscosity MS₁₊₄(100° C.) of the natural rubber can be 50 or less, 40 or less, or even 30 or less. The Mooney viscosity MS₁₊₄(100° C.) can be adjusted by a general method such as mastication.

MMA can be added onto the natural rubber in the presence of a radical polymerization initiator. Examples of the radical polymerization initiator include general peroxide-based initiators, azo-based initiators, and a redox-based initiator by combination of a peroxide and a reducing agent. These can be used singly as one species or in a combination of two or more species. Among them, a peroxide-based initiator is preferable. Examples of the peroxide-based initiator include diacyl peroxides such as aromatic diacyl peroxides typified by benzoyl peroxide (BPO) and aliphatic diacyl peroxides such as dialkyloyl peroxides (e.g. dilauroyl peroxide). Other examples of the peroxide-based initiator include t-butyl hydroperoxide, di-t-butyl peroxide, t-butyl peroxybenzoate, dicumyl peroxide, 1,1-bis(t-butylperoxy)-3,3,5-trimethylcyclohexane, and 1,1-bis(t-butylperoxy)cyclododecane. For the peroxide-based initiator, solely one species or a combination of two or more species can be used.

The base polymer of the PSA may consist of one, two or more species of MMA-modified natural rubbers, or it may comprise an MMA-modified natural rubber and other polymer(s) together. The ratio of the MMA-modified natural rubber to the entire base polymer is not particularly limited. It can be suitably selected in the range above 0% by weight and below 100% by weight. In some embodiments, the MMA-modified natural rubber content can be, for instance, 10% by weight or higher. From the standpoint of enhancing the heat-resistant holding properties, it is usually advantageously 25% by weight or higher, or preferably 40% by weight or higher. In some embodiments, the MMA-modified natural rubber content can be above 50% by weight, 65% by weight or higher, 80% by weight or higher, or even 90% by weight or higher. It is noted that when an MMA-modified natural rubber is used solely as the base polymer, the MMA-modified natural rubber accounts for 100% by weight of the entire base polymer.

From the standpoint of the miscibility, as the polymer used together with the MMA-modified natural rubber, for instance, a rubber-based polymer can be preferably used. As the rubber-based polymer, either a natural rubber or a synthetic rubber (e.g. styrene-butadiene rubber, styrene-butadiene block copolymer, styrene-isobutylene block copolymer, etc.) can be used. From the standpoint of increasing the biomass carbon ratio, it is particularly preferable to use a natural rubber which is a biomass material. The base polymer may consist of an MMA-modified natural rubber and a natural rubber, or it may include an MMA-modified natural rubber, a natural rubber and other polymer(s) altogether. In some embodiments, besides the MMA-modified natural rubber and the natural rubber, the other polymer content is suitably below 30% by weight of the entire base polymer, preferably below 20% by weight, or possibly below 10% by weight.

When using a natural rubber, the ratio of the natural rubber to the total amount of the MMA-modified natural rubber and natural rubber can be above 0% by weight. For instance, it can be 5% by weight or higher, 10% by weight or higher, 25% by weight or higher, or even 40% by weight or higher. With increasing ratio of natural rubber, the biomass carbon ratio of the PSA tends to increase. The ratio of the natural rubber to the total amount of the MMA-modified natural rubber and natural rubber can be below 100% by weight; it can also be 95% by weight or lower, 75% by weight or lower, or even 60% by weight or lower. From the standpoint of enhancing the heat-resistant holding properties, in some embodiments, the natural rubber can be used in an amount of 50% by weight or less, 45% by weight or less, 35% by weight or less, or even 25% by weight or less.

Other polymers that can be used in combination with the MMA-modified natural rubber include an acrylic polymer and a polyester-based polymer. The acrylic polymer may be formed from a monomer mixture comprising a monomer having biomass-derived carbons. A preferable polyester-based polymer is formed from a polycarboxylic acid (typically a dicarboxylic acid) and a polyol (typically a diol) of which at least one is a compound comprising partially or entirely biomass-derived carbons, for instance, a plant-derived compound. As the biomass-derived dicarboxylic acid, for instance, a dimeric acid derived from a plant-derived unsaturated fatty acid (sebacic acid, oleic acid, erucic acid, etc.) can be used. As the biomass-derived diol, for instance, a dimeric diol obtainable by reduction of the dimeric acid, biomass ethylene glycol obtainable from biomass ethanol as the starting material, or the like can be used. Such a polyester-based polymer may have a biomass carbon ratio of, for instance, above 40%, preferably above 50%, 70% or higher, 85% or higher, 90% or higher, or even 100%. From the standpoint of the miscibility, etc., the polyester-based polymer is usually suitably used in an amount accounting for less than 20% by weight of the entire base polymer, preferably less than 10% by weight, or possibly even less than 5% by weight.

The PSA sheet disclosed herein can be preferably made in an embodiment where at least 20% (by weight) of all repeat units forming the base polymer is attributed to a repeat unit derived from an acrylic monomer. In other words, it is preferable that at least 20% of the total weight of the base polymer comes from the acrylic monomer. Hereinafter, the ratio of the weight coming from the acrylic monomer to the total weight of the base polymer may be referred to as the “acrylate ratio.” When the base polymer comprises at least the certain percentage of the acrylic monomer-derived repeat unit, the cohesive strength of the natural rubber-based PSA can be increased, improving heat-resistant holding properties of the PSA sheet. This can bring about, for instance, a PSA sheet suited for fixing parts of electronic devices without requiring the use of a vulcanizer or sulfur-containing vulcanization accelerator.

From the standpoint of increasing the cohesive strength of the PSA, the acrylate ratio of the base polymer can be, for instance, higher than 20% by weight, preferably 24% by weight or higher, 28% by weight or higher, or even 33% by weight or higher. From the standpoint of placing more emphasis on the cohesive strength, in some embodiments, the acrylate ratio of the base polymer can be 35% by weight or higher, 38% by weight or higher, or even 40% by weight or higher. The maximum acrylate ratio of the base polymer is selected so that the PSA layer has a biomass carbon ratio of 50% by weight or higher. From the standpoint of increasing the biomass carbon ratio of the PSA layer, the lower the acrylate ratio of the base polymer is, the more advantageous it is. From such a standpoint, in typical, the acrylate ratio of the base polymer is suitably below 70% by weight, preferably below 60% by weight, possibly below 55% by weight, or even below 50% by weight. From the standpoint of further increasing the biomass carbon ratio, in some embodiments, the acrylate ratio of the base polymer can be below 45% by weight, below 42% by weight, or even below 39% by weight.

The acrylic monomer-derived repeat unit in the base polymer includes the MMA-derived repeat unit forming the MMA-modified natural rubber. The acrylic monomer-derived repeat unit in the base polymer may consist of the MMA-derived repeat unit forming the MMA-modified natural rubber or may further include other acrylic monomer-derived repeat unit(s). The ratio of the weight of the MMA-derived repeat unit forming the MMA-derived natural rubber to the total weight of acrylic monomer-derived repeat unit(s) in the base polymer can be, for instance, higher than 50% by weight, 75% by weight or higher, 90% by weight or higher, or essentially 100% by weight as well.

### (Crosslinking Agent)

In the PSA layer of the PSA sheet disclosed herein, a crosslinking agent is preferably used. The crosslinking agent may contribute to greater heat-resistant holding properties. This can effectively enhance the heat-resistant holding properties. The crosslinking agent can be selected among various crosslinking agents known in the field of PSA. Examples of the crosslinking agent include isocyanate-based crosslinking agent, epoxy-based crosslinking agent, oxazoline-based crosslinking agent, aziridine-based crosslinking agent, melamine-based crosslinking agent, peroxide-based crosslinking agent, urea-based crosslinking agent, metal alkoxide-based crosslinking agent, metal chelate-based crosslinking agent, metal salt-based crosslinking agent, [symbol] carbodiimide-based crosslinking agent, and amine-based crosslinking agent. As the crosslinking agent, solely one species or a combination of two or more species can be used.

When using a crosslinking agent, the amount used is not particularly limited. The amount of crosslinking agent used to 100 parts by weight of base polymer can be selected from a range of, for instance, 0.001 part to 15 parts by weight. From the standpoint of obtaining greater heat-resistant holding properties and tight adhesion to adherend in a well-balanced manner, the amount of crosslinking agent used to 100 parts by weight of base polymer is usually preferably 12 parts by weight or less, possibly 8 parts by weight or less, or 6 parts by weight or less; it is suitably 0.005 part by weight or greater, or possibly 0.01 part by weight or greater.

The crosslinking agent is preferably selected among sulfur-free crosslinking agents. Here, the sulfur-free crosslinking agent means a crosslinking agent that is at least free of intentionally-added sulfur (S) and the concept of this material is clearly distinct from a vulcanizer which is generally used as a crosslinking agent for natural rubber. A crosslinking agent whose active ingredient is a compound free of sulfur as a constituent is a typical example of the sulfur-free crosslinking agent referred to here. The sulfur-free crosslinking agent is used as the crosslinking agent to avoid incorporation of sulfur from the crosslinking agent into the PSA layer. This can be an advantageous feature in a PSA sheet used in the field of electronic devices for which the presence of sulfur is undesirable. In the PSA sheet disclosed herein, it is preferable that no vulcanizer is used in the PSA layer.

In some embodiments, the crosslinking agent preferably comprises at least an isocyanate-based crosslinking agent. As the isocyanate-based crosslinking agent, solely one species or a combination of two or more species can be used. The isocyanate-based crosslinking agent can also be used in combination with other crosslinking agent(s), for instance, an epoxy-based crosslinking agent.

As the isocyanate-based crosslinking agent, a polyisocyanate-based crosslinking agent having at least two isocyanate groups per molecule is preferably used. The number of isocyanate groups per molecule of polyisocyanate-based crosslinking agent is preferably 2 to 10, for instance, 2 to 4, or typically 2 or 3. Examples of the polyisocyanate-based crosslinking agent include aromatic polyisocyanates such as tolylene diisocyanate and xylene diisocyanate; alicyclic isocyanates such as isophorone diisocyanate; and aliphatic polyisocyanates such as hexamethylene diisocyanate. More specific examples include lower aliphatic polyisocyanates such as butylene diisocyanate and hexamethylene diisocyanate; alicyclic polyisocyanates such as cyclopentylene diisocyanate, cyclohexylene diisocyanate and isophorone diisocyanate; aromatic diisocyanates such as 2,4-tolylene diisocyanate, 4,4′-diphenylmethane diisocyanate, xylylene diisocyanate and polymethylene polyphenyl isocyanate; isocyanate adducts such as trimethylolpropane-tolylene diisocyanate trimer adduct (product name CORONATE L available from Tosoh Corporation), a trimethylolpropane-hexamethylene diisocyanate trimer adduct (product name CORONATE HL available from Tosoh Corporation), and isocyanurate of hexamethylene diisocyanate (product name CORONATE HX available from Tosoh Corporation); polyisocyanates such as polyether polyisocyanate and polyester polyisocyanate; adducts of these polyisocyanates and various polyols; and polyisocyanates polyfunctionalized with isocyanurate bonds, biuret bonds, allophanate bonds, etc.

When using an isocyanate-based crosslinking agent, relative to 100 parts by weight of base polymer, it can be used in an amount of, for instance, about 0.1 part by weight or greater, 0.5 part by weight or greater, 1.0 part by weight or greater, or even greater than 1.5 parts by weight. From the standpoint of obtaining greater effects of its use, the amount of isocyanate-based crosslinking agent used to 100 parts by weight of base polymer can be, for instance, greater than 2.0 parts by weight, 2.5 parts by weight or greater, or even 2.7 parts by weight or greater. The amount of isocyanate-based crosslinking agent used to 100 parts by weight of base polymer is usually suitably 10 parts by weight or less, possibly 7 parts by weight or less, or even 5 parts by weight or less. From the standpoint of avoiding a decrease in tightness of adhesion to adherend caused by excessive crosslinking, it may be advantageous to not use an excessive amount of isocyanate-based crosslinking agent.

As the epoxy-based crosslinking agent, a polyfunctional epoxy compound having at least two epoxy groups per molecule can be used. Examples include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic acid diglycidyl ester, triglycidyl-tris(2-hydroxyethyl) isocyanurate, resorcine diglycidyl ether, bisphenol-S-diglycidyl ether and an epoxy-based resin having at least two epoxy groups per molecule. Examples of commercial epoxy-based crosslinking agents include TETRAD C and TETRAD X available from Mitsubishi Gas Chemical, Inc.

When using an epoxy-based crosslinking agent, relative to 100 parts by weight of base polymer, it can be used in an amount of, for instance, about 0.005 part by weight or greater; or from the standpoint of obtaining greater effects of its use, 0.01 part by weight or greater, or even 0.02 part by weight or greater. The amount of epoxy-based crosslinking agent used to 100 parts by weight of base polymer is usually suitably 2 parts by weight or less, possibly 1 part by weight or less, 0.5 part by weight or less, or even 0.1 part by weight or less. From the standpoint of avoiding a decrease in tightness of adhesion to adherend caused by excessive crosslinking, it may be advantageous to not use an excessive amount of epoxy-based crosslinking agent.

When using an isocyanate-based crosslinking agent and a different crosslinking agent (i.e. non-isocyanate-based crosslinking agent) together, the relative amounts of the isocyanate-based crosslinking agent and non-isocyanate-based crosslinking agent (e.g. an epoxy-based crosslinking agent) are not particularly limited. From the standpoint of favorably combining tight adhesion to adherend and heat-resistant holding properties, in some embodiments, the non-isocyanate-based crosslinking agent content can be, by weight, about ½ of the isocyanate-based crosslinking agent content or less, about ⅕ or less, about 1/10 or less, about 1/20 or less, or even about 1/30 or less. From the standpoint of favorably obtaining the effects of the combined use of isocyanate-based crosslinking agent and non-isocyanate-based crosslinking agent (e.g. an epoxy-based crosslinking agent), the non-isocyanate-based crosslinking agent content is usually suitably about 1/1000 of the isocyanate-based crosslinking agent content or greater, for instance, about 1/500 or greater.

To efficiently carry out the crosslinking reaction by an aforementioned crosslinking agent, a crosslinking catalyst can also be used. As the crosslinking catalyst, for instance, a tin-based catalyst can be preferably used such as dioctyltin dilaurate. The amount of crosslinking catalyst used is not particularly limited. For instance, to 100 parts by weight of base polymer, it can be about 0.0001 part to 1 part by weight.

Another example of the crosslinking agent that can be used in the PSA layer of the PSA sheet disclosed herein is a monomer having two or more polymerizable functional groups per molecule, that is, a polyfunctional monomer. Examples of the polyfunctional monomer include ethylene glycol di(meth)acrylate, propylene glycol di(meth)acrylate, polyethylene glycol di(meth)acrylate, polypropylene glycol di(meth)acrylate, neopentyl glycol di(meth)acrylate, pentaerythritol di(meth)acrylate, pentaerythritol tri(meth)acrylate, dipentaerythritol hexa(meth)acrylate, ethylene glycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, urethane acrylate, butanediol (meth)acrylate and hexanediol (meth)acrylate.

When using a polyfunctional monomer as the crosslinking agent, its amount used will depend on its molecular weight, the number of functional groups therein, etc. It is usually suitably in a range of about 0.01 part to 3.0 parts by weight to 100 parts by weight of base polymer. In some embodiments, from the standpoint of obtaining greater effects, the amount of polyfunctional monomer used to 100 parts by weight of base polymer can be, for instance, 0.02 part by weight or greater, or even 0.03 part by weight or greater. On the other hand, from the standpoint of avoiding a decrease in tack caused by an excessive increase in cohesive strength, the amount of polyfunctional monomer used to 100 parts by weight of base polymer can be 2.0 parts by weight or less, 1.0 part by weight or less, or even 0.5 part by weight or less.

The PSA layer in the PSA sheet disclosed herein may be subjected to electron beam crosslinking (a crosslinking treatment by electron beam irradiation) for the purpose of increasing the cohesive strength, etc. The electron beam-induced crosslinking can be carried out in place of or in combination with the use of an aforementioned crosslinking agent.

### (Tackifier)

The PSA in the art disclosed herein may have a composition that includes a tackifier (typically a tackifier resin). The use of tackifier may improve the properties (e.g. heat-resistant holding properties and/or peel strength) of the PSA sheet. The tackifier is not particularly limited. For instance, various tackifier resins can be used, such as rosin-based tackifier resins, terpene-based tackifier resins, hydrocarbon-based tackifier resins and phenolic tackifier resins. These tackifiers can be used singly as one species or in a combination of two or more species.

Specific examples of the rosin-based tackifier resin include unmodified rosins (raw rosins) such as gum rosin, wood rosin and tall-oil rosin; modified rosins (hydrogenated rosins, disproportionated rosins, polymerized rosins, other chemically-modified rosins, etc.) obtainable by subjecting these unmodified rosins to modifications such as hydrogenation, disproportionation and polymerization; and various other rosin derivatives. Examples of the rosin derivatives include rosin esters such as rosin esters obtainable by esterifying unmodified rosins with alcohols (i.e. esterified rosins) and modified rosin esters obtainable by esterifying modified rosins (hydrogenated rosins, disproportionated rosins, polymerized rosins, etc.) with alcohols (i.e. esterified modified rosins); unsaturated fatty acid-modified rosins obtainable by modifying unmodified rosins or modified rosins (hydrogenated rosins, disproportionated rosins, polymerized rosins, etc.) with unsaturated fatty acids; unsaturated fatty acid-modified rosin esters obtainable by modifying rosin esters with unsaturated fatty acids; rosin alcohols obtainable by reduction of carboxy groups in unmodified rosins, modified rosins (hydrogenated rosins, disproportionated rosins, polymerized rosins, etc.), unsaturated fatty acid-modified rosins, or unsaturated fatty acid-modified rosin esters; metal salts of rosins such as unmodified rosins, modified rosins and various rosin derivatives (especially rosin esters); and rosin phenol resins obtainable by subjecting rosins (hydrogenated rosins, disproportionated rosins, polymerized rosins, etc.) to acid-catalyzed phenol addition followed by thermal polymerization.

Examples of the terpene-based tackifier resin include terpene-based resins such as α-pinene polymers, β-pinene polymers and dipentene polymers; and modified terpene-based resins obtainable by subjecting these terpene-based resins to modifications (phenol modification, aromatic modification, hydrogenation, hydrocarbon modification, etc.). Examples of the modified terpene resin include terpene phenol-based resins, styrene modified terpene-based resins, aromatic modified terpene-based resins and hydrogenated terpene-based resins.

Examples of the hydrocarbon-based tackifier resin include various hydrocarbon resins such as aliphatic hydrocarbon resins, aromatic hydrocarbon resins, aliphatic cyclic hydrocarbon resins, aliphatic/aromatic petroleum resins (styrene-olefin copolymers and the like), aliphatic/alicyclic petroleum resins, hydrogenated hydrocarbon resin, coumarone resins, and coumarone indene resins.

Examples of the aliphatic hydrocarbon resins include polymers of one, two or more species of aliphatic hydrocarbons selected among olefins and dienes having about 4 to 5 carbon atoms. Examples of the olefin include 1-butene, isobutylene and 1-pentene. Examples of the diene include butadiene, 1,3-pentadiene and isoprene.

Examples of the aromatic hydrocarbon resins include polymers of vinyl-group-containing aromatic hydrocarbons (styrene, vinyl toluene, α-methyl styrene, indene, methyl indene, etc.) having 8 to 10 carbon atoms. Examples of the alicyclic hydrocarbon resins include alicyclic hydrocarbon-based resins obtainable by polymerization of cyclic dimers of so-called “C4 petroleum fractions” and “C5 petroleum fractions”; polymers of cyclic diene compounds (cyclopentadiene, dicyclopentadiene, ethylidene norbornene, dipentene, etc.) or hydrogenation products of these polymers; and alicyclic hydrocarbon-based resins obtainable by hydrogenation of aromatic rings in aromatic hydrocarbon resins or aliphatic-aromatic petroleum resins.

When the PSA layer disclosed herein includes a tackifier, from the standpoint of increasing the biomass carbon ratio of the PSA layer, it is preferable to use a tackifier derived from a plant (i.e. a plant-based tackifier) as the tackifier. Examples of the plant-based tackifier may include the aforementioned rosin-based tackifier resins and terpene-based tackifier resins. The plant-based tackifiers can be used singly as one species or in a combination of two or more species. When the PSA layer disclosed herein includes a tackifier, the ratio of plant-based tackifier to the total amount of tackifier is preferably 30% by weight or higher (e.g. 50% by weight or higher, typically 80% by weight or higher). In a particularly preferable embodiment, the ratio of plant-based tackifier to the total amount of tackifier is 90% by weight or higher (e.g. 95% by weight or higher, typically 99% to 100% by weight). The art disclosed herein can be preferably implemented in an embodiment essentially free of a non-plant-based tackifier.

In the art disclosed herein, it is preferable to use a tackifier resin having a softening point (softening temperature) of about 60° C. or higher (preferably about 80° C. or higher, more preferably about 95° C. or higher, e.g. about 105° C. or higher). Such a tackifier resin can bring about a PSA sheet having superior properties (e.g. improved heat-resistant holding properties and/or improved heat-resistant peel strength). The maximum softening point of the tackifier resin is not particularly limited. In some embodiments, from the standpoint of the miscibility, etc., the tackifier resin can have a softening point of about 200° C. or lower, about 180° C. or lower, about 140° C. or lower, or even about 120° C. or lower. The softening point of tackifier resin referred to herein is defined as the value measured by the softening point test method (ring and ball method) specified either in JIS K5902:2006 or in JIS K2207:2006.

The amount of tackifier resin used is not particularly limited. It can be suitably selected in accordance with desired adhesive properties (displaced length in the heat-resistant holding power test, peel strength, etc.). In some embodiments, the amount of tackifier resin used to 100 parts by weight of base polymer can be, for instance, 5 parts by weight or greater, usually suitably 15 parts by weight or greater, 30 parts by weight or greater, 40 parts by weight or greater, 50 parts by weight or greater, or even 65 parts by weight or greater. In view of the balance among adhesive properties, in some embodiments, the amount of tackifier resin used to 100 parts by weight of base polymer can be, for instance, 200 parts by weight or less, usually suitably 150 parts by weight or less, possibly 120 parts by weight or less, 100 parts by weight or less, or even 85 parts by weight or less.

### (Other Components)

Th PSA layer may include various additives generally known in the field of PSA compositions as necessary, such as a leveling agent, plasticizer, filler, colorant (pigment, dye, etc.), antistatic agent, anti-aging agent, UV absorber, antioxidant and photo-stabilizer. As for these various additives, heretofore known species can be used by typical methods.

When the PSA layer includes a filler, the filler content can be selected from, for instance, a range of above 0 part by weight and 200 parts by weight or below (preferably 100 parts by weight or below, e.g. 50 parts by weight or below) relative to 100 parts by weight of base polymer. From the standpoint of preventing the filler from falling out of the PSA layer, in some embodiment, the filler content relative to 100 parts by weight of base polymer is suitably less than 30 parts by weight, preferably less than 20 parts by weight, more preferably less than 10 parts by weight, possibly less than 5 parts by weight, or even less than 1 part by weight.

When the PSA layer includes a plasticizer, the plasticizer content can be selected from, for instance, a range of above 0 part by weight and 35 parts by weight or below relative to 100 parts by weight of base polymer. From the standpoint of facilitating to obtain high heat-resistant holding properties suited for fixing parts, the plasticizer content is preferably 25 parts by weight or less, or more preferably 15 parts by weight or less. From the standpoint of reducing the amount of possible volatile(s) arising from the plasticizer, in some embodiments, the plasticizer content relative to 100 parts by weight of base polymer is suitably less than 10 parts by weight, possibly less than 5 parts by weight, less than 3 parts by weight, or even less than 1 part by weight. Especially, when the PSA sheet is for internal use in an electronic device or for use in a precision electronic instrument, it is advantageous to reduce the plasticizer content or to not use any plasticizer.

In the PSA layer, it is preferable that neither vulcanizer nor sulfur-containing vulcanization accelerator (thiuram-based vulcanization accelerator, dithiocarbamate-based vulcanization accelerator, thiazole-based vulcanization accelerator, etc.) is used. This can be an advantageous feature as a PSA sheet used in the field of electronic devices for which the presence of sulfur is undesirable. In the PSA layer of the PSA sheet disclosed herein, it is preferable to avoid the use of any sulfur-containing material, not just vulcanizers and vulcanization accelerators.

The PSA layer (layer formed of PSA) in the PSA sheet disclosed herein can be formed from a PSA composition having such a composition. The form of PSA composition is not particularly limited. For instance, it can be an aqueous PSA composition, solvent-based PSA composition, hot-melt PSA composition, or active energy ray-curable PSA composition. Here, the aqueous PSA composition refers to a PSA composition comprising a PSA (PSA layer-forming components) in a solvent (an aqueous solvent) primarily comprising water and the concept encompasses a water-dispersed PSA composition in which the PSA is dispersed in water and a water-soluble PSA composition in which the PSA is dissolved in water. The solvent-based PSA composition refers to a PSA composition comprising a PSA in an organic solvent. The PSA sheet disclosed herein can be preferably made in an embodiment having a PSA layer formed from a solvent-based PSA composition.

The PSA layer disclosed herein can be formed from a PSA composition by a heretofore known method. For instance, with respect to a substrate-free double-faced PSA sheet, a PSA sheet can be formed by applying a PSA composition to a releasable surface (release face) and allowing the PSA composition to cure to form a PSA layer on the surface. As for a substrate-supported PSA sheet, it is preferable to employ a method (direct method) for forming a PSA layer where a PSA composition is directly provided (typically applied) to the substrate and allowed to cure. Alternatively, it is also possible to employ a method (transfer method) where a PSA composition is provided to a releasable surface (release face) and allowed to cure to form a PSA layer on the surface and the resulting PSA layer is transferred to a substrate. As the release face, the surface of a release liner, the substrate's backside that has been treated with release agent, or the like can be used. The PSA composition can be cured by subjecting the PSA composition to a curing process such as drying, crosslinking, polymerization, cooling, etc. Two or more different curing processes can be carried out at the same time or stepwise. The PSA layer disclosed herein is not limited to, but is typically formed in a continuous form. For instance, the PSA layer may be formed in a regular or random pattern of dots, stripes, etc.

The PSA composition can be applied, using a heretofore known coater, for instance, a gravure roll coater, reverse roll coater, kiss roll coater, dip roll coater, die coater, bar coater, knife coater and spray coater. Alternatively, the PSA composition can be applied by immersion, curtain coating, etc.

From the standpoints of accelerating the crosslinking reaction, improving production efficiency, and the like, it is preferable to dry the PSA composition under heating. The drying temperature can be, for example, about 40° C. to 150° C., and usually temperature of about 60° C. to 130° C. is preferable. After drying the PSA composition, aging may be implemented for purposes such as adjusting the distribution or migration of components in the PSA layer, advancing the crosslinking reaction, and lessening possible strain in the substrate and the PSA layer.

In the PSA sheet disclosed herein, the thickness of the PSA layer is not particularly limited and can be suitably selected in accordance with the purpose. In view of the balance between adhesion to adherend and heat-resistant holding properties, the thickness of the PSA layer can be, for instance, about 2 μm to 500 μm. From the standpoint of the adhesion to adherend, the thickness of the PSA layer is usually suitably 3 μm or greater, or preferably 5 μm or greater. From the standpoint of readily obtaining a PSA sheet that shows greater heat-resistant holding properties, in some embodiments, the thickness of the PSA layer can be, for instance, 8 μm or greater, preferably 12 μm or greater, 15 μm or greater, 20 μm or greater, or even 25 μm or greater. From the standpoint of making the PSA sheet thinner, the thickness of the PSA layer can be, for instance, 200 μm or less, 150 μm or less, 100 μm or less, 70 μm or less, 50 μm or less, or even 30 μm or less. In an embodiment where thinning is of greater importance, the thickness of the PSA layer can be, for instance, 20 μm or less, 15 μm or less, 12 μm or less, 9 μm or less, or even 7 μm or less. When the PSA sheet disclosed herein is a double-faced PSA sheet having a PSA layer on each face of a substrate, the respective PSA layers may have the same thickness or different thicknesses.

### <Substrate>

The PSA sheet disclosed herein may be in a substrate-supported PSA sheet form having a PSA layer on one or each face of a substrate. As the substrate, various substrates in sheet forms can be used. For instance, resin film, paper, fabrics, rubber sheets, foam sheets, metal foil, a composite of these and the like can be used. For use in electronic devices, it is preferable to use a substrate that is less likely to form dust (e.g. fine fibers or particles such as paper dust). From such a standpoint, a preferable substrate is free of fibrous substances such as paper and fabrics. For instance, it is preferable to use resin film, a rubber sheet, a foam sheet, metal foil, a composite of these or the like.

Examples of the resin film include polyester films such as polyethylene terephthalate (PET) and polyethylene naphthalate; vinyl chloride resin film; polyolefin films such as polyethylene (PE), polypropylene (PP), ethylene-propylene copolymer, and ethylene-butylene copolymer; vinylidene chloride resin film; vinyl acetate resin film; polystyrene film; polyacetal film; polyimide film; polyamide film; fluororesin film; and cellophane. Examples of the rubber sheet include a natural rubber sheet and a butyl rubber sheet. Examples of the foam sheet include a polyurethane foam sheet and a polyolefin foam sheet. Examples of the metal foil include aluminum foil and copper foil. Among them, resin films are preferable from the standpoint of the size stability, thickness precision, cost, ease of processing, tensile strength, etc. As used herein, the “resin film” typically refers to a non-porous film and is conceptually distinct from so-called non-woven and woven fabrics.

In some embodiments, from the standpoint of the strength and the ease of processing, polyester film is preferably used as the substrate. As the polyester resin forming the polyester film, in typical, a polyester resin whose primary component is a polyester obtainable by polycondensation of a dicarboxylic acid and a diol is used.

Examples of the dicarboxylic acid forming the polyester include aromatic dicarboxylic acids such as phthalic acid, isophthalic acid, terephthalic acid, 2-methylterephthalic acid, 5-sulfoisophthalic acid, 4,4′-diphenyldicarboxylic acid, 4,4′-diphenyl ether dicarboxylic acid, 4,4′-diphenyl ketone dicarboxylic acid, 4,4′-diphenoxyethane dicarboxylic acid, 4,4′-diphenylsulfone dicarboxylic acid, 1,4-naphthalene dicarboxylic acid, 1,5-naphthalene dicarboxylic acid, 2,6-naphthalene dicarboxylic acid and 2,7-naphthalene dicarboxylic acid; alicyclic dicarboxylic acids such as 1,2-cyclohexane dicarboxylic acid, 1,3-cyclohexane dicarboxylic acid, and 1,4-cyclohexane dicarboxylic acid; aliphatic dicarboxylic acids such as malonic acid, succinic acid, glutaric acid, adipic acid, pimelic acid, suberic acid, azelaic acid, sebacic acid, and dodecanoic acid; unsaturated dicarboxylic acids such as maleic acid, anhydrous maleic acid, and fumaric acid; and derivatives of these (e.g. lower alcohol esters of the dicarboxylic acids such as terephthalic acid, etc.). These can be used singly as one species or in a combination of two or more species.

Examples of the diol forming the polyester include aliphatic diols such as ethylene glycol, diethylene glycol, polyethylene glycol, propylene glycol, polypropylene glycol, 1,3-propanediol, 1,5-pentanediol, neopentyl glycol, 1,4-butanediol, 1,6-hexanediol, 1,8-octanediol, and polyoxytetramethylene glycol; alicyclic diols such as 1,2-cyclohexanediol, 1,4-cyclohexanediol, 1,1-cyclohexanedimethylol, and 1,4-cyclohexanedimethylol; and aromatic diols such as xylylene glycol, 4,4′-dihydroxybiphenyl, 2,2-bis(4′-hydroxyphenyl)propane, and bis(4-hydroxyphenyl)sulfone. These can be used singly as one species or in a combination of two or more species. From the standpoint of the transparency, etc., aliphatic diols are preferable and ethylene glycol is particularly preferable. The ratio of the aliphatic diol (preferably ethylene glycol) in the diol forming the polyester is preferably 50% by weight or higher (e.g. 80% by weight or higher, typically 95% by weight or higher). The diol may essentially consist of ethylene glycol. As the ethylene glycol, it is preferable to use biomass-derived ethylene glycol (typically biomass ethylene glycol obtained from biomass ethanol as the starting material). For instance, of the ethylene glycol forming the polyester, the ratio of biomass-derived ethylene glycol can be, for instance, 50% by weight or higher, preferably 75% by weight or higher, 90% by weight or higher, or even 95% by weight or higher. Essentially all of the ethylene glycol can be biomass-derived ethylene glycol.

Examples of the polyester resin film include polyethylene terephthalate (PET), polybutylene terephthalate (PBT), and polyethylene naphthalate (PEN).

When the substrate disclosed herein is a polyester film substrate, the polyester film substrate may include a non-polyester polymer in addition to the polyester. Favorable examples of the non-polyester polymer include those that are not polyester among the various polymer materials exemplified earlier as the resin film possibly forming the substrate. When the polyester film substrate disclosed herein includes a non-polyester polymer, the non-polyester polymer content is suitably less than 100 parts by weight to 100 parts by weight of polyester, preferably 50 parts by weight or less, more preferably 30 parts by weight or less, or yet more preferably 10 parts by weight or less. The non-polyester polymer content relative to 100 parts by weight of polyester can be 5 parts by weight or less, or even 1 part by weight or less. The art disclosed herein can be preferably implemented in an embodiment where, for instance, the polyester film substrate is 99.5% to 100% polyester by weight.

In some other embodiments, from the standpoint of the strength and flexibility, a polyolefin film can be preferably used as the substrate. The polyolefin film comprises, as the primary component, a polymer whose primary monomer (the primary component among the monomers) is an α-olefin. The ratio of the polymer is usually 50% by weight or higher (e.g. 80% by weight or higher, typically 90% to 100% by weight). Specific examples of the polyolefin include a species whose primary monomer is ethylene (i.e. polyethylene) and a species whose primary monomer is propylene (i.e. polypropylene).

The polyethylene can be ethylene homopolymer, a copolymer of ethylene and other olefin(s) (e.g. one, two or more species selected among α-olefins with 3 to 10 carbon atoms), or a copolymer of ethylene and non-olefin monomer(s) (e.g. one, two or more species selected among ethylenically unsaturated monomers such as vinyl acetate, acrylic acid, methacrylic acid, methyl acrylate and ethyl acrylate). The polypropylene can be propylene homopolymer, a copolymer of propylene and other olefin(s) (e.g. one, two or more species selected among α-olefins with 2 or 4 to 10 carbon atoms), or a copolymer of propylene and non-olefin monomer(s). The substrate disclosed herein may consist of one species of polyolefin among these or may include two or more species of polyolefin.

When the substrate disclosed herein is a polyolefin film substrate, the polyolefin film substrate may include a non-polyolefin polymer in addition to the polyolefin(s). Favorable examples of the non-polyolefin polymer include those that are not polyolefins among the various polymer materials exemplified earlier as the resin film possibly forming the substrate. When the polyolefin film substrate disclosed herein includes a non-polyolefin polymer, the non-polyolefin polymer content is suitably less than 100 parts by weight to 100 parts by weight of polyolefin, preferably 50 parts by weight or less, more preferably 30 parts by weight or less, or yet more preferably 10 parts by weight or less. The non-polyolefin polymer content relative to 100 parts by weight of polyolefin can be 5 parts by weight or less, or even 1 part by weight or less. The art disclosed herein can be preferably implemented in an embodiment where, for instance, the polyolefin film substrate is 99.5% to 100% polyolefin by weight.

From the standpoint of reducing the usage of fossil-resource-based materials, the substrate disclosed herein preferably comprises a biomass material. The biomass material possibly forming the substrate is not particularly limited. Examples include biomass polyesters such as biomass PET and biomass polytrimethylene terephthalate (biomass PTT); polylactic acid; biomass polyolefins such as biomass polyethylenes including biomass high density polyethylene (biomass HDPE), biomass low density polyethylene (biomass LDPE) and biomass linear low density polyethylene (biomass LLDPE) as well as biomass polypropylene (biomass PP); biomass poly(3-hydroxybutyrate-co-3-hydroxyhexanoate); biomass polyamides such as polyhexamethylene sebacamide and poly(xylene sebacamide); biomass polyurethanes such as biomass polyester ether urethane and biomass polyether urethane; and cellulose-based resins. Among these, solely one species or a combination of two or more species can be used. In particular, biomass PET and biomass PTT are preferable; and biomass HDPE, biomass LDPE, biomass LLDPE and biomass PP and biomass PET are especially preferable. These biomass materials are resin materials and thus can be preferably used in an embodiment where the substrate is a resin film. With the use of the biomass material, the usage of fossil-resource-based materials can be reduced in the PSA sheet using the resin film (preferably a polyolefin film) as the substrate.

In the PSA sheet in an embodiment having a substrate, the biomass carbon ratio of the substrate is preferably 20% or higher, or more preferably 35% or higher. When the reduction of usage of fossil-resource-based materials is of greater importance, the biomass carbon ratio of the substrate can be, for instance, 50% or higher, 70% or higher, 85% or higher, or even 90% or higher. While the maximum biomass carbon ratio is 100% or lower, in some embodiments, in view of the ease of processing, strength, etc., the biomass carbon ratio of the substrate can be, for instance, 80% or lower, 60% or lower, 40% or lower, or even below 20%. Here, similar to the biomass carbon ratio of the PSA layer, the biomass carbon ratio of the substrate refers to the ratio of biomass-derived carbons in the total carbon content of the substrate. The biomass carbon ratio of the substrate can be estimated from the carbon-14 isotope content determined based on ASTM D6866. The same applies to the biomass carbon ratio of the PSA sheet described later.

The face of the substrate (e.g. resin film, a rubber sheet, a foam sheet, etc.) on which the PSA layer is placed (i.e. the PSA layer-side surface) may be subjected to a known or common surface treatment such as corona discharge treatment, plasma treatment, UV irradiation, acid treatment, base treatment and formation of a primer layer. Such surface treatment may be carried out to increase the tightness of adhesion between the substrate and the PSA layer, that is, the anchoring of the PSA layer to the substrate. Alternatively, the substrate may be free of any surface treatment to enhance the anchoring of the PSA layer-side surface. When forming a primer layer, the primer used for the formation is not particularly limited and a suitable species can be selected among known primers. The thickness of the primer layer is not particularly limited. For instance, it can be above 0.00 μm; and it is usually suitably 0.1 μm or greater. From the standpoint of obtaining greater effects, it can also be 0.2 μm or greater. The thickness of the primer layer is preferably less than 1.0 μm, or possibly 0.7 μm or less, or even 0.5 μm or less. In general, primers are heavily dependent on fossil-resource-based materials; and therefore, from the standpoint of increasing the biomass carbon ratio of the PSA sheet described later, it may be advantageous that the primer layer does not have an excessively large thickness.

In a single-faced PSA sheet having a PSA layer on one face of the substrate, the PSA layer-free face (backside) of the substrate may be subjected to release treatment with a release agent (backside treatment agent). The backside treatment agent possibly used for formation of the backside treatment layer is not particularly limited. It is possible to use silicone-based backside treatment agents, fluorine-based backside treatment agents, long-chain alkyl-based backside treatment agents and other known or common agents in accordance with the purpose and application. For the backside treatment agent, solely one species or a combination of two or more species can be used.

To the substrate (e.g. a resin film substrate), various additives can be added as necessary, such as a filler (inorganic filler, organic filler, etc.), anti-aging agent, antioxidant, UV absorber, antistatic agent, slip agent, plasticizer and colorant (pigment, dye, etc.). The amount of the various additives is usually about 30% by weight or less (e.g. 20% by weight or less, typically 10% by weight or less) in the substrate. For instance, when a pigment (e.g. white pigment) is included in the substrate, the pigment content is suitably about 0.1% to 10% by weight (e.g. 1% to 8% by weight, typically 1% to 5% by weight).

The thickness of the substrate is not particularly limited and can be suitably selected in accordance with the purpose. In general, it is about 1 μm to 500 μm. From the standpoint of the handling properties of the substrate, the thickness of the substrate can be, for instance, 1.5 μm or greater, 2 μm or greater, 3 μm or greater, 4 μm or greater, or even 4.5 μm or greater. From the standpoint of making the PSA sheet thinner, in some embodiment, the thickness of the substrate can be, for instance, 150 μm or less, 100 μm or less, 50 μm or less, 25 μm or less, 20 μm or less, 10 μm or less, 7 μm or less, less than 5 μm, or even less than 4 μm.

### <PSA Sheet>

The thickness (total thickness) of the PSA sheet disclosed herein (which includes the PSA layer and further includes the substrate in a substrate-supported PSA sheet, but excludes any release liner) is not particularly limited. It can be in a range of, for instance, about 2 μm to 1000 μm. In some embodiments, in view of the adhesive properties, etc., the thickness of the PSA sheet is preferably about 5 μm to 500 μm (e.g. 10 μm to 300 μm, typically 15 μm to 200 μm). Alternatively, in some embodiments where thinning is considered important, the PSA sheet may have a thickness of 100 μm or less (e.g. 5 μm to 100 μm), 70 μm or less (e.g. 5 μm to 70 μm), or even 45 μm or less (e.g. 5 μm to 45 μm).

In the PSA sheet disclosed herein, biomass-derived carbons preferably account for more than 40% of the total carbon content therein. In other words, the PSA sheet preferably has a biomass carbon ratio above 40%. With the use of a PSA sheet with such a high biomass carbon ratio, the usage of fossil-resource-based materials can be reduced. From such a standpoint, it can be said that the higher the biomass carbon ratio of the PSA sheet is, the more preferable it is. The biomass carbon ratio of the PSA sheet is preferably 50% or higher, possibly 60% or higher, 70% or higher, 75% or higher, or even 80% or higher. The maximum biomass carbon ratio is 100% by definition; however, in the PSA sheet disclosed herein, because the base polymer of the PSA includes a repeat unit derived from MMA, the biomass carbon ratio is typically below 100%. From the standpoint of readily obtaining properties (e.g. high heat-resistant holding properties) suited for use in electronic devices, in some embodiments, the biomass carbon ratio of the PSA sheet can be, for instance, 95% or lower. When adhesive properties are of greater importance, it can be 90% or lower, or even 85% or lower.

It is noted that in a substrate-free PSA sheet formed of a PSA layer, the biomass carbon ratio of the PSA layer equals that of the entire PSA sheet. Thus, when the PSA sheet disclosed herein is a substrate-free PSA sheet, the biomass carbon ratio of the substrate-free PSA sheet is 50% or higher, typically 50% or higher and lower than 100%.

The PSA sheet disclosed herein is characterized by showing a displaced length of 1.0 mm/60 min or less in the heat-resistant holding power test carried out at 80° C. The PSA sheet showing such heat-resistant holding properties can exhibit good holding properties even in a temperature range above room temperature. From the standpoint of obtaining greater holding properties, the displaced length is preferably 0.3 mm/60 min or less, or more preferably 0.2 mm/60 mm or less. The minimum displaced length is 0.0 mm/60 min and this means that no displacement is observed in the heat-resistant holding power test. From the standpoint of the heat-resistant holding properties, the smaller the displaced length is, the more preferable it is; and it can be even 0.0 mm/60 min. On the other hand, from the standpoint of facilitating to increase the biomass carbon ratio of the PSA layer, in some embodiments, the displaced length can also be, for instance, 0.1 mm/60 min or greater.

The displaced length in the heat-resistant holding power test can be determined by the following method: In particular, a PSA sheet is cut to a 10 mm wide, 100 mm long size to prepare a measurement sample. In an environment at 23° C. and 50% RH, the adhesive face of the measurement sample is press-bonded with a 2 kg roller moved back and forth once to a Bakelite plate (phenol resin plate) as the adherend over a 10 mm wide, 20 mm long bonding area. With the length direction of the test piece coinciding with the vertical direction, the adherend with the test piece applied thereto is vertically suspended and left as is in an environment at 80° C. Then, a 500 g load is attached to the free end of the test piece; and based on JIS 20237, it is left standing with the attached load at 80° C. for 60 minutes. After this, with respect to the test piece, the distance displaced from the initial position (displaced length or displaced distance, hereinafter) is determined. If the test piece falls off the Bakelite plate within 60 minutes, “20 mm/60 min” is given as the displaced length or simply “Fell off” is indicated as the result.

It is noted that, for the measurement, a suitable backing material can be applied to the PSA sheet subject to measurement to reinforce it as necessary (e.g. in case of a substrate-free double-faced PSA sheet, in case of a substrate-supported PSA sheet whose substrate is susceptible to deformation, etc.). The same is true with the peel strength measurement described later. As the backing material, for instance, PET film of about 25 μm in thickness can be used. Such a backing material was used in the working examples described later.

In a test of heat-resistant holding power under a heavy load (heavy-load heat-resistant holding power test) which is carried out in the same manner as the heat-resistant holding power test except that a 1 kg load is attached to the free end of the test piece, the PSA sheet according to some embodiments shows a displaced length of preferably 1.0 mm/60 min or less, more preferably 0.5 mm/60 min or less, or yet more preferably 0.2 mm/60 min or less. From the standpoint of the heat-resistant holding properties, the smaller the displaced length is, the more preferable it is; and it can be even 0.0 mm/60 min. On the other hand, from the standpoint of facilitating to increase the biomass carbon ratio of the PSA layer, in some embodiments, the displaced length can also be, for instance, 0.1 mm/60 min or greater.

The PSA sheet according to some embodiments preferably has a peel strength to stainless steel plate of 5 N/20 mm or greater. The PSA sheet showing such properties strongly bonds to an adherend; and therefore, typically it can be preferably used in an embodiment where it does not intend re-peeling. From the standpoint of achieving more highly reliable bonding, the peel strength can be, for instance, 10 N/20 mm or greater, preferably 11 N/20 mm or greater, 12 N/20 mm or greater, 13 N/20 mm or greater, 14 N/20 mm or greater, or even 15 N/20 mm or greater. The maximum peel strength is not particularly limited. In general, the higher the more preferable. On the other hand, from the standpoint of facilitating to increase the biomass carbon ratio of the PSA layer, in some embodiments, the peel strength can be, for instance, 50 N/20 mm or less, 40 N/20 mm or less, or even 30 N/20 mm or less. Hereinafter, the peel strength may be referred to as the to-SUS peel strength as well.

The to-SUS peel strength can be determined by the following method: A PSA sheet is cut to a 20 mm wide, 150 mm long size to prepare a measurement sample. In an environment at 23° C. and 50% RH, the adhesive face of the measurement sample is exposed and press-bonded to a stainless steel plate (SUS304BA plate) as the adherend with a 2 kg rubber roller moved back and forth once. The resultant is left standing in an environment at 50° C. for two hours. Subsequently, in an environment at 23° C. and 50% RH, using a tensile tester, the peel strength (180° peel strength) (N/20 mm) is determined at a peel angle of 180°, at a tensile speed of 300 mm/min, based on JIS Z0237:2000. As the tensile tester, a universal tensile/compression testing machine (machine name “tensile and compression testing machine, TCM-1kNB” available from Minebea Co., Ltd.) can be used. The same method has been used in the working examples described later as well.

The PSA sheet according to some embodiments has a heat-resistant peel strength to stainless steel plate of preferably 4 N/20 mm or greater, more preferably 5 N/20 mm or greater, or yet more preferably 7 N/20 mm or greater. The PSA sheet showing such properties can achieve more highly reliable bonding. The maximum heat-resistant peel strength is not particularly limited. In general, the higher the more preferable. On the other hand, from the standpoint of facilitating to increase the biomass carbon ratio of the PSA layer, in some embodiments, the heat-resistant peel strength can be, for instance, 30 N/20 mm or less, or even 20 N/20 mm or less. The heat-resistant peel strength can be determined in the same manner as the to-SUS peel strength described above, except that the adhesive face of the measurement sample is press-bonded to a stainless steel plate (SUS304BA plate) in an environment at 23° C. and 50% RH and the resultant is then left standing in an environment at 80° C. for 30 minutes. The same method is used for the working examples described later.

The PSA sheet according to some embodiments has a peel strength to polypropylene (PP) plate (to-PP peel strength) of preferably 8 N/20 mm or greater, more preferably 10 N/20 mm or greater, or yet more preferably 13 N/20 mm or greater. The PSA sheet showing such properties can strongly bond to a low-polar adherend such as a polyolefinic resin. The maximum to-PP peel strength is not particularly limited. In general, the higher the more preferable. On the other hand, from the standpoint of easily increasing the biomass carbon ratio of the PSA layer, in some embodiments, the to-PP peel strength can be, for instance, 40 N/20 mm or less, 30 N/20 mm or less, or even 25 N/20 mm or less. The to-PP peel strength can be determined in the same manner as for the to-SUS peel strength described above, except that a polypropylene resin plate is used as the adherend. The same method is used for the working examples described later as well.

In some embodiments, the ratio of to-SUS peel strength to to-PP peel strength (i.e. the PP/SUS peel strength ratio) can be, for instance, 0.5 or higher, preferably 0.7 or higher, or even 0.9 or higher. The PP/SUS peel strength ratio can be, for instance, 3 or lower, 2 or lower, or even 1.5 or lower. The closer to 1 the PP/SUS peel strength ratio is, the smaller the difference in peel strength is depending on the kind of adherend material is. Such a PSA sheet is preferable because it is highly versatile and is also suited for bonding and fixing different materials.

The PSA sheet according to some embodiments has a peel strength to polyethylene (PE) plate (to-PE peel strength) of suitably 1.5 N/20 mm or greater, preferably 3 N/20 mm or greater, more preferably 5 N/20 mm or greater, or yet more preferably 8 N/20 mm or greater. The PSA sheet showing such properties can strongly bond to a low-polar adherend such as a polyolefinic resin. The maximum to-PE peel strength is not particularly limited. In general, the higher the more preferable. On the other hand, from the standpoint of easily increasing the biomass carbon ratio of the PSA layer, in some embodiments, the to-PE peel strength can be, for instance, 30 N/20 mm or less, or even 20 N/20 mm or less. The to-PE peel strength can be determined in the same manner as for the to-SUS peel strength described above, except that a polyethylene resin plate is used as the adherend. The same method is used for the working examples described later as well.

The PSA sheet disclosed herein is preferably halogen-free (chlorine-free, in particular). A halogen-free PSA sheet can be made by avoiding the use of a halogen-containing material. For instance, with respect to the PSA layer, it is desirable to avoid using an additive that contains a halogenated polymer (e.g. a chlorinated rubber such as polychloroprene rubber). In a substrate-supported PSA sheet, it is desirable to avoid using, as a component of the substrate, a halogenated resin (e.g. vinyl chloride resin) or an additive that contains chlorine.

The PSA sheet disclosed herein is preferably constituted so that it satisfies at least one of the following: (A) the chlorine content is 0.09% (900 ppm) by weight or less, (B) the bromine content is 0.09% (900 ppm) by weight or less, and (C) their combined content (chlorine and bromine combined content) is 0.15% (1500 ppm) by weight or less. More preferably, at least (A) is satisfied. Yet more preferably, (A) and (C) are satisfied. Especially preferably, all (A), (B) and (C) are satisfied. The chlorine content and the bromine content can be determined by known methods such as fluorescent X-ray analysis and ion chromatography.

### <Applications>

The PSA sheet disclosed herein can be used, for instance, in an embodiment where it is applied to a part of an electronic device, for purposes such as fixing, attaching and reinforcing the part. The PSA sheet disclosed herein can be preferably used, typically as a double-faced PSA sheet, to fix or attach parts. In such an application, it is particularly significant that the PSA sheet shows good shear bonding strength. The double-faced sheet may be free of a substrate or may include a substrate. From the standpoint of making it thinner, in an embodiment, it may be preferable to select a substrate-free PSA sheet form or a substrate-supported PSA sheet form that uses a thin substrate. As the thin substrate, a substrate having a thickness of 10 μm or less (e.g. less than 5 μm) can be preferably used.

The PSA sheet disclosed herein is suitable, for example, for fixing members in mobile electronic devices. Non-limiting examples of the mobile electronic devices include a cellular phone, a smartphone, a tablet type personal computer, a notebook type personal computer, various wearable devices (for example, wrist wearable devices such as a wrist watch, modular devices worn on part of a body with a clip, a strap, or the like, eyewear type devices inclusive of eyeglasses type devices (monocular and binocular type; including head-mounted device), devices attached to clothing, for example, in the form of an accessory on a shirt, a sock, a hat, or the like, earwear type devices which are attached to the ear, such as an earphone), a digital camera, a digital video camera, an acoustic device (a mobile music player, an IC recorder, and the like), a calculator (electronic calculator and the like), a mobile game machine, an electronic dictionary, an electronic notebook, an e-book reader, an information device for an automobile, a mobile radio, a mobile television, a mobile printer, a mobile scanner, and a mobile modem. The PSA sheet disclosed herein can be preferably used, for example, for the purpose of fixing a pressure-sensitive sensor and other members in those mobile electronic devices, among the abovementioned mobile electronic devices, that include a pressure-sensitive sensor. In one preferred embodiment, the PSA sheet can be used for fixing a pressure-sensitive sensor and other members in an electronic device (typically, a mobile electronic device) having a function of enabling the designation of an absolute position on a plate corresponding to the screen (typically, a touch panel) in an apparatus for indicating the position on a screen (typically, a pen type or a mouse type apparatus) and an apparatus for detecting the position. The term “mobile” in this description means not just providing simple mobility, but further providing a level of portability that allows an individual (average adult) to carry it relatively easily.

The matters disclosed herein include the following:

(1) A PSA sheet for use in an electronic device, having a PSA layer formed from a natural rubber-based PSA, wherein

the PSA comprises a base polymer comprising a methyl methacrylate-modified natural rubber,

the PSA layer includes biomass-derived carbons accounting for 50% or more (typically 50% or more and less than 100%) of its total carbon content, and

the PSA sheet shows a displaced distance of 1.0 mm/60 min or less in a heat-resistant holding power test carried out at 80° C.

(2) The PSA sheet according to (1) above, wherein the methyl methacrylate-modified natural rubber content of the base polymer is 40% by weight or higher and 100% by weight or lower.
(3) The PSA sheet according to (1) or (2) above, wherein the PSA layer comprises a crosslinking agent.
(4) The PSA sheet according to any of (1) to (3) above, wherein the crosslinking agent is selected among sulfur-free crosslinking agents.
(5) The PSA sheet according to (3) or (4) above, wherein the crosslinking agent comprises an isocyanate-based crosslinking agent.
(6) The PSA sheet according to any of (1) to (5) above, wherein the PSA layer includes a tackifier derived from a plant (a plant-derived tackifier).
(7) The PSA sheet according to (6) above, wherein the plant-derived tackifier is included in an amount of 30 parts by weight or greater (typically 30 parts by weight or greater and 100 parts by weight or less) to 100 parts by weight of the base polymer.
(8) The PSA sheet according to (6) or (7) above, wherein the plant-derived tackifier comprises at least one species selected from the group consisting of terpene-based resins and modified terpene-based resins.
(9) The PSA sheet according to any of (1) to (8) above, wherein the PSA layer has a thickness of 8 μm or greater (typically 8 μm or greater and 500 μm or less).
(10) The PSA sheet according to any of (1) to (9) above, having a peel strength to stainless steel plate of 5 N/20 mm or greater (e.g. 5 N/20 mm or greater and 50 N/20 mm or less).
(11) The PSA sheet according to any of (1) to (10) above, the ratio of the weight of the methyl methacrylate-derived repeat unit to the weight of the methyl methacrylate-modified natural rubber is 10% by weight or above and below 80% by weight.
(12) The PSA sheet according to any of (1) to (11) above, formed as an adhesively double-faced (double-sided) PSA sheet.
(13) The PSA sheet according to (12) above, formed as a substrate-free double-faced PSA sheet formed of the PSA layer.
(14) The PSA sheet according to (12) above, formed as a substrate-supported double-faced PSA sheet having a substrate supporting the PSA layer.
(15) The PSA sheet according to (14) above, wherein the substrate is a resin film.
(16) The PSA sheet according to (14) or (15), wherein the substrate comprises biomass-derived carbons accounting for 20% or more (typically 20% or more and 100% or less) of its total carbon content.
(17) The PSA sheet according to any of (1) to (16) above, comprising biomass-derived carbons accounting for at least 50% of its total carbon content.
(18) The PSA sheet according to any of (1) to (17) above, wherein the PSA layer includes a plasticizer and the plasticizer content is 35 parts by weight or less (typically 0 part by weight or greater and 35 parts by weight or less) to 100 parts by weight of the base polymer.
(19) The PSA sheet according to any of (1) to (18) above, wherein the PSA layer includes a filler in an amount of less than 10 parts by weight (typically, 0 part by weight or greater and less than 10 parts by weight) to 100 parts by weight of the base polymer.
(20) The PSA sheet according to any of (1) to (19) above, used for fixing a part of an electronic device.

### EXAMPLES

Several working examples related to the present invention are described below, but these working examples are not to limit the present invention. In the description below, “parts” and “%” are by weight unless otherwise specified.

<Preparation of MMA-modified natural rubber>
(MMA-modified natural rubber A)

To a toluene solution containing 49 parts of natural rubber (RSS1 grade, after mastication; or natural rubber NR-1, hereinafter), were added 36 parts of methyl methacrylate (MMA) and 0.4 part of a peroxide-based initiator and solution polymerization was carried out to obtain a toluene solution of MMA-modified natural rubber A (modified rubber A). As the peroxide-based initiator, were used BPO (NYPER BW available from NOF Corporation) and dilauroyl peroxide (PEROYL L available from NOF Corporation) at a weight ratio of about 1:1.7.

### (MMA-Modified Natural Rubber B)

To a toluene solution containing 50 parts of natural rubber (RSS1 grade, after mastication; or natural rubber NR-2, hereinafter), were added 50 parts of MMA and 0.3 part of a peroxide-based initiator and solution polymerization was carried out to obtain a toluene solution of MMA-modified natural rubber B (modified rubber B). As the peroxide initiator, was used the same BPO as the one used in preparation of the MMA-modified natural rubber A. It is noted that for the natural rubber NR-2, the time for mastication was reduced to one-third that for the natural rubber NR-1

### <Preparation of PSA Sheet>

### Example 1

To the toluene solution of MMA-modified natural rubber A, with respect to 100 parts of MMA-modified natural rubber A in the solution, were added 70 parts of a terpene-based tackifier resin (YS RESIN PX1150N available from Yasuhara Chemical Co., Ltd. softening point: 115±5° C.; or tackifier resin TF-2, hereinafter), 3 parts of an anti-aging agent (phenolic anti-aging agent, IRGANOX 1010 available from BASF Corporation) and 4 parts of an isocyanate-based crosslinking agent (CORONATE L available from Tosoh Corporation). The resulting mixture was allowed to stir evenly to prepare a PSA composition C-1 according to this Example.

To the release face of a 38 μm thick release liner (DIAFOIL MRF38 available from Mitsubishi Polyester Film, Inc.; or release liner R1, hereinafter) with the release face formed with a silicone-based release agent on one face of polyester film, was applied the PSA composition C-1 and allowed to dry at 100° C. for 2 minutes to form a 30 μm thick PSA layer. To the PSA layer, was adhered the release face of a 25 μm thick release liner (DIAFOIL MRF25 available from Mitsubishi Polyester Film, Inc.; or release liner R2, hereinafter) with the release face formed with a silicone-based release agent on one face of polyester film. By this, was obtained a substrate-free double-faced PSA sheet according to Example 1 with the two faces protected with the two polyester release liners.

### Example 2

The amount of PSA composition C-1 applied was adjusted to form a 50 μm thick PSA layer. Otherwise in the same manner as Example 1, was obtained a substrate-free double-faced PSA sheet according to Example 2.

### Example 3

To the toluene solution of MMA-modified natural rubber A, with respect to 85 parts of MMA-modified natural rubber A in the solution, was added 15 parts of natural rubber NR-2. To 100 parts of the MMA-modified natural rubber A and natural rubber NR-2 combined, were added the same amounts of terpene-based tackifier resin, anti-aging agent and isocyanate-based crosslinking as in Example 1. The resulting mixture was allowed to stir evenly to prepare a PSA composition C-3 according to this Example.

In place of the PSA composition C-1, was used the PSA composition C-3. Otherwise in the same manner as Example 1, was obtained a substrate-free double-faced PSA sheet according to this Example.

### Examples 4 to 15

For each Example, the species and amounts of MMA-modified natural rubber and natural rubber, the species and amount of tackifier resin, the species and amount of crosslinking agent and the thickness of the PSA layer were modified as shown in Table 1. Otherwise in the same manner as Examples 1 to 3, were prepared PSA compositions C4 to C15 according to Examples 4 to 15.

Here, as the tackifier resin TF-1 shown in Table 1, was used a terpene-phenol resin (YS POLYSTER S-145 available from Yasuhara Chemical Co., Ltd. softening point 145° C.). As the epoxy-based crosslinking agent shown in Table 1, was used 1,3-bis(N,N-diglycidylaminomethyl)cyclohexane (TETRAD C available from Mitsubishi Gas Chemical Company, Inc.).

In place of the PSA composition C-1, were used the PSA compositions C-4 to C-15. Otherwise in the same manner as Example 1, were obtained substrate-free double-faced PSA sheets according to the respective Examples.

### Example 16

The PSA composition C-1 prepared in Example 1 was applied to the respective release faces of release liners R1 and R2, and allowed to dry at 100° C. for 2 minutes to form 4 μm thick PSA layers. To the first and second faces of 2 μm thick transparent polyethylene film as the substrate, were adhered the PSA layers, respectively, to obtain a substrate-supported double-faced PSA sheet according to Example 16 with the two faces protected with the two release liners R1 and R2.

### Examples 17 to 19

For each Example, the thickness of the substrate and the thickness of the PSA layer formed on each face of the substrate (the PSA layer's thickness per face) were as shown in Table 2. Otherwise in the same manner as Example 16, were obtained substrate-supported double-faced PSA sheets according to the respective Examples.

### <Measurements and Evaluation>

With respect to the PSA sheet obtained in each Example, the peel strength as well as the displaced distances in the heat-resistant holding power test and heavy-load heat-resistant holding power test were determined by the methods described earlier. In addition, with respect to the PSA sheet (a substrate-free double-faced PSA sheet formed of a PSA layer, or a substrate-supported double-faced PSA sheet) according to each Example, the biobased content of the PSA forming the PSA layer was determined based on ASTM D6866. With respect to the substrate-supported double-faced PSA sheets of Examples 16 to 19, the biobased content of each PSA sheet was further determined. The results are shown in Tables 1 and 2. The symbol “-” in the peel strength column indicates that it was not determined. It is noted that when the test piece fell off the Bakelite plate within 60 minutes in the heat-resistant holding power test or heavy-load heat-resistance holding power test, “Fell off” is shown in the column for the displaced distance.

TABLE 1

| | | Example | | | | | | | |
|---|---|---|---|---|---|---|---|---|---|
| | | 1 | 2 | 3 | 4 | 5 | 6 | 7 | 8 |
| MMA-modified | Modified rubber A | 100 | 100 | 85 | 85 | — | — | 100 | 100 |
| natural rubber | Modified rubber B | — | — | — | — | 85 | 85 | — | — |
| (parts by weight) | | | | | | | | | |
| Rubber-based polymer | NR-1 | — | — | — | 15 | — | 15 | — | — |
| (parts by weight) | NR-2 | — | — | 15 | — | 15 | — | — | — |
| Tackifier resin | TF-1 | — | — | — | — | — | — | — | — |
| (parts by weight) | TF-2 | 70 | 70 | 70 | 70 | 70 | 70 | 70 | 50 |
| Crosslinking agent | Isocyanate-based | 4 | 4 | 4 | 4 | 4 | 4 | 2 | 4 |
| (parts by weight) | Epoxy-based | — | — | — | — | — | — | 0.05 | — |
| Origin of repeat unit | Natural rubber | 57 | 57 | 64 | 64 | 64 | 64 | 57 | 57 |
| (% by weight) | Acrylic monomer | 43 | 43 | 36 | 36 | 36 | 36 | 43 | 43 |
| | (acrylate ratio) | | | | | | | | |
| Biobased content of PSA (%) | | 85 | 85 | 89 | 89 | 87 | 87 | 89 | 86 |
| Thickness of PSA layer (μm) | | 30 | 50 | 30 | 30 | 30 | 30 | 30 | 30 |
| Peel strength | to-SUS (23° C.) | 14.3 | 15.0 | 15.5 | 15.7 | 16.7 | 18.6 | 18.0 | 12.4 |
| (N/20 mm) | to-SUS (80° C.) | 6.9 | 6.3 | 7.0 | 7.7 | 7.5 | 8.7 | — | — |
| | to-PP (23° C.) | 17.0 | 17.7 | 16.5 | — | — | — | 17.8 | 15.7 |
| | to-PE (23° C.) | 11.7 | 15.1 | 8.5 | — | — | — | — | — |
| Displaced distance | 80° C., 0.5 kg | 0.1 | 0.1 | 0.1 | 0.1 | 0.1 | 0.1 | 0.1 | 0.1 |
| [mm/60 min] | 80° C., 1.0 kg | 0.1 | 0.1 | 0.1 | 0.1 | 0.1 | 0.1 | 0.1 | 0.1 |

| | | Example | | | | | | |
|---|---|---|---|---|---|---|---|---|
| | | 9 | 10 | 11 | 12 | 13 | 14 | 15 |
| MMA-modified | Modified rubber A | 85 | 85 | 85 | 85 | 85 | 50 | — |
| natural rubber | Modified rubber B | — | — | — | — | — | — | — |
| (parts by weight) | | | | | | | | |
| Rubber-based polymer | NR-1 | — | — | — | — | — | — | — |
| (parts by weight) | NR-2 | 15 | 15 | 15 | 15 | 15 | 50 | 100 |
| Tackifier resin | TF-1 | 35 | 70 | — | — | — | — | — |
| (parts by weight) | TF-2 | 35 | — | 70 | 70 | 70 | 70 | 70 |
| Crosslinking agent | Isocyanate-based | 4 | 4 | 4 | 4 | 4 | 4 | 4 |
| (parts by weight) | Epoxy-based | — | — | — | — | — | — | — |
| Origin of repeat unit | Natural rubber | 64 | 64 | 64 | 64 | 64 | 79 | 100 |
| (% by weight) | Acrylic monomer | 36 | 36 | 36 | 36 | 36 | 21 | 0 |
| | (acrylate ratio) | | | | | | | |
| Biobased content of PSA (%) | | 84 | 78 | 89 | 89 | 89 | 93 | 96 |
| Thickness of PSA layer (μm) | | 30 | 30 | 50 | 10 | 20 | 30 | 30 |
| Peel strength | to-SUS (23° C.) | 15.1 | 11.2 | 16.0 | 12.0 | 15.5 | 13.5 | 10.4 |
| (N/20 mm) | to-SUS (80° C.) | 9.5 | 7.3 | — | — | — | 7.2 | 8.9 |
| | to-PP (23° C.) | — | — | 18.0 | 11.0 | 16.5 | — | — |
| | to-PE (23° C.) | — | — | 9.5 | 2.0 | 7.0 | — | — |
| Displaced distance | 80° C., 0.5 kg | 0.1 | 0.1 | 0.1 | 0.1 | 0.1 | 0.3 | Fell |
| [mm/60 min] | | | | | | | | off |
| | 80° C., 1.0 kg | 0.1 | 0.1 | 0.1 | 0.1 | 0.1 | Fell | Fell |
| | | | | | | | off | off |

TABLE 2

| | | Example | | | |
|---|---|---|---|---|---|
| | | 16 | 17 | 18 | 19 |
| MMA-modified | Modified rubber A | 100 | 100 | 100 | 100 |
| natural rubber | Modified rubber B | — | — | — | — |
| (parts by weight) | | | | | |
| Rubber-based polymer | NR-1 | — | — | — | — |
| (parts by weight) | NR-2 | — | — | — | — |
| Tackifier resin | TF-1 | — | — | — | — |
| (parts by weight) | TF-2 | 70 | 70 | 70 | 70 |
| Crosslinking agent | Isocyanate-based | 4 | 4 | 4 | 4 |
| (parts by weight) | Epoxy-based | — | — | — | — |
| Origin of repeat unit | Natural rubber | 57 | 57 | 57 | 57 |
| (% by weight) | Acrylic monomer | 43 | 43 | 43 | 43 |
| | (acrylate ratio) | | | | |
| Biobased content of PSA (%) | | 85 | 85 | 85 | 85 |
| Thickness of PSA layer (per face) (μm) | | 4 | 14 | 13 | 19 |
| Thickness of substrate (μm) | | 2 | 2 | 4 | 12 |
| Thickness of PSA sheet (μm) | | 10 | 30 | 30 | 50 |
| Biobased content of PSA sheet (%) | | 68 | 79 | 73 | 64 |
| Peel strength | to-SUS (23° C.) | 5.6 | 14.2 | 13.5 | 14.4 |
| (N/20 mm) | to-SUS (80° C.) | 4.3 | 5.7 | 6.4 | 6.2 |
| | to-PP (23° C.) | 8.6 | 14.7 | 14.3 | 15.2 |
| Displaced distance | 80° C., 0.5 kg | 0.1 | 0.1 | 0.1 | 0.1 |
| [mm/60 min] | 80° C., 1.0 kg | 0.1 | 0.1 | 0.1 | 0.1 |

As shown in Table 1, with respect to the substrate-free double-faced PSA sheets of Examples 1 to 14 each formed of a PSA layer using an MMA-modified rubber as the base polymer showed clearly superior heat-resistant holding properties as compared to the PSA sheet of Example 15. The PSA sheets of Examples 1 to 13 had greater heat-resistant holding properties than the PSA sheet of Example 14. Similarly, as shown in Table 2, good heat-resistant holding properties were obtained with the substrate-supported double-faced PSA sheets of Examples 16 to 19, with each face of the substrate having a PSA layer using an MMA-modified rubber as the base polymer. The PSA sheets of Examples 1 to 14 and 16 to 19 also showed high peel strength values in addition to the good heat-resistant holding properties, showing to have properties suited for fixing parts.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1, 2, 3 PSA sheets
10 support substrate
10A first face
10B second face (backside)
21 PSA layer (first PSA layer)
21A adhesive face (first adhesive face)
21B second adhesive face
22 PSA layer (second PSA layer)
22A adhesive face (second adhesive face)
31, 32 release liners
100, 200, 300 release-linered PSA sheets

1. A pressure-sensitive adhesive sheet for use in an electronic device, having a pressure-sensitive adhesive layer formed from a natural rubber-based pressure-sensitive adhesive, wherein
the pressure-sensitive adhesive comprises a base polymer comprising a methyl methacrylate-modified natural rubber,
the pressure-sensitive adhesive layer includes biomass-derived carbons accounting for 50% or more of its total carbon content, and
the pressure-sensitive adhesive sheet shows a displaced length of 10 mm/60 min or less in a heat-resistant holding power test carried out at 80° C.

2. The pressure-sensitive adhesive sheet according to claim 1, wherein the methyl methacrylate-modified natural rubber content of the base polymer is 40% by weight or higher and 100% by weight or lower.

3. The pressure-sensitive adhesive sheet according to claim 1, wherein the pressure-sensitive adhesive layer comprises a crosslinking agent.

4. The pressure-sensitive adhesive sheet according to claim 1, wherein the pressure-sensitive adhesive layer comprises a plant-derived tackifier.

5. The pressure-sensitive adhesive sheet according to claim 4, wherein the tackifier content is 30 parts by weight or higher to 100 parts by weight of the base polymer.

6. The pressure-sensitive adhesive sheet according to claim 1, having a peel strength to stainless steel plate of 5 N/20 mm or greater.

7. The pressure-sensitive adhesive sheet according to claim 1, formed as an adhesively double-faced pressure-sensitive adhesive sheet.

8. The pressure-sensitive adhesive sheet according to claim 1, comprising biomass-derived carbons accounting for 50% or more of its total carbon content.

9. The pressure-sensitive adhesive sheet according to claim 1, used for fixing a part of an electronic device.
